(19) United States
(12) Patent Application Publication
(10) Pub. No.: US 2010/0050192 A1
(43) Pub. Date: Feb. 25, 2010

(54) DISK CONVEYANCE DEVICE AND DISK DEVICE

(75) Inventors: Hideo Ito, Kanagawa (JP); Eiji Hoshinaka, Kanagawa (JP); Yoshihiro Ichikawa, Kanagawa (JP); Tomonari Ishikawa, Kanagawa (JP)

Correspondence Address: KRATZ, QUINTOS & HANSON, LLP, 1420 K Street, N.W., Suite 400, WASHINGTON, DC, 20005, US

(73) Assignee: PIONEER CORPORATION, Tokyo (JP)

(21) Appl. No.: 12/522,730

(22) PCT Filed: Jan. 11, 2007
(86) PCT No.: PCT/JP2007/050250

§ 371 Date: Jul. 30, 2009

(51) Int. Cl. G11B 17/04; G11B 33/04

(52) U.S. Cl. 720/601; 206/308.1; G9B/17.013

(57) ABSTRACT

A disc device includes. a case having an opening; and a tray that is movable to and retractable from the case and is provided on one surface thereof with an arc recess capable of holding an optical disc. The tray includes a cutout portion that is provided near a rear face of the arc recess and guides an inserted distal end of the optical disc toward a bottom side of the tray lower than an upper face of the arc recess.

### TECHNICAL FIELD

The present invention relates to a disc transfer device for transferring a disc recording medium, and a disc device.

### BACKGROUND ART

There has been known a disc device that mounts a disc on a tray to transfer the disc into the device (see, for instance, Patent Document 1).

Patent Document 1 discloses that an optical disc device including a drawer in which a disc driving mechanism is mounted is slidably supported on a bottom plate of the optical disc device by guide rails provided on both sides of the drawer. This optical disc device is arranged so that the drawer is locked when whole of the drawer is ejected out of the bottom plate during ejection of the drawer (see FIGS. 1 and 3 of Patent Document 1).

Patent Document 1. JP-A-2006-190352

### DISCLOSURE OF THE INVENTION

### Problems to Be Solved by the Invention

In a typical disc device as disclosed in Patent Document 1 above, whole of the tray is supported by the two guide rails provided on the both sides of the drawer. Accordingly, for example, when the drawer is completely ejected (see FIGS. 1 and 3 of Patent Document 1), the drawer is likely to incline downward due to impact given to the drawer and the drawer's own weight, so that strength of the drawer is unstable.

It is conceived that a chassis and a part of a tray are arranged to overlap with each other against such disadvantage. However, due to a depth of a slim drive disc device is standardized, a disc mounting portion on the tray overlaps with the chassis. Accordingly, it is required to lessen an insertion angle of a disc to be mounted on the tray. Consequently, it is difficult to center the disc on a turntable.

An object of the present invention is to provide a disc transfer device that can favorably transfer a disc-shaped recording medium, and a disc device in view of the above problem.

### Means for Solving the Problems

A disc transfer device according to an aspect of the invention includes. a case including an opening on at least one side thereof and an inner space connected to the opening; and a tray that is advanceable and retractable through the opening of the case and is provided with an holding recess having a holding surface capable of holding a disc-shaped recording medium at a first surface, in which the tray includes a guide that is provided on the holding recess near the case in a moving direction of the tray, the guide guiding a periphery of the recording medium to be inserted from the holding surface to a second surface where the holding recess is not provided.

A disc device according to the aspect of the invention includes. the disc transfer device described above; the holder for holding the recording medium; and an information processor for performing at least one of a reading processing that reads out information on the recording medium held by the holder and a recording processing that records information on the recording medium.

### BRIEF DESCRIPTION OF DRAWINGS

FIG. 1 is a plan view showing an arrangement of a tray and a case when the tray is ejected out of the case in a disc device according to a first exemplary embodiment of the invention.

FIG. 2 is a plan view showing a vicinity of a rear face of the tray.

FIG. 3 is a cross section showing the vicinity of the rear face of the tray.

FIG. 4 is a lateral cross section in the disc device according to the first exemplary embodiment when an optical disc is inserted into the tray.

FIG. 5 is a lateral cross section in the disc device according to the first exemplary embodiment when the optical disc is further inserted into the tray.

FIG. 6 is a lateral cross section in the disc device according to the first exemplary embodiment when the optical disc is mounted on the tray.

FIG. 7 is a plan view showing a vicinity of a rear face of a tray in a disc device according to a second exemplary embodiment.

FIG. 8 is a lateral cross section showing the vicinity of the rear face of the tray in the disc device according to the second exemplary embodiment.

FIG. 9 is a lateral cross section in the disc device according to the second exemplary embodiment when the tray is housed in a case.

FIG. 10 is a lateral cross section in the disc device according to the first exemplary embodiment when a large-diameter disc is inserted into the tray.

FIG. 11 is a lateral cross section in the disc device according to the second exemplary embodiment when the tray is being housed in the case.

FIG. 12 is a lateral cross section in the disc device according to the second exemplary embodiment when a small-diameter disc is inserted into the tray.

FIG. 13 is a plan view showing an arrangement of a tray and a case when the tray is ejected out of the case in a disc device according to another exemplary embodiment of the invention.

FIG. 14 is a plan view showing an inner arrangement in the disc device of FIG. 13 when the tray is housed in the case.

### EXPLANATION OF CODES

23 . . . turntable serving as a holder
24 . . . information processor
100 . . . disc device functioning as a disc transfer device as well
200 . . . case
201A . . . opening
202 . . . rear face
203 . . . bottom face
220 . . . guide-plate pushup cam as a cam
300 . . . tray
310 . . . arc recess serving as a holding recess
320 . . . cutout portion serving as a guide
321,322 . . . straight cutout portion serving as a straight portion
323 . . . projecting portion serving as a positioning portion
325 . . . rotary shaft
330 . . . guide plate serving as a turn plate
332 . . . biasing spring serving as a biasing unit
333 . . . rising portion serving as a large-diameter recording medium abutting portion
334 . . . arc cutout portion serving as a small-diameter recording medium positioning portion
350 . . . positioning lever
351 . . . disc abutting portion serving as a positioning portion
352 . . . case abutting portion serving as a rotation acting portion
L . . . imaginary line

### BEST MODE FOR CARRYING OUT THE INVENTION

### First Exemplary Embodiment

### Arrangement of Disc Device

A disc device according to a first exemplary embodiment of the invention will be described below with reference to the attached drawings.

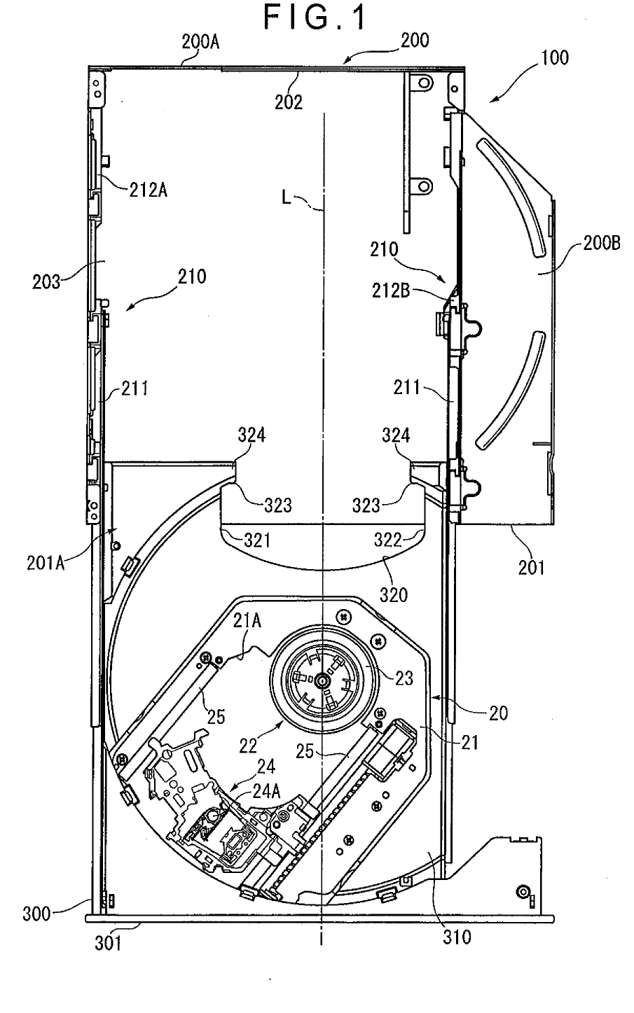

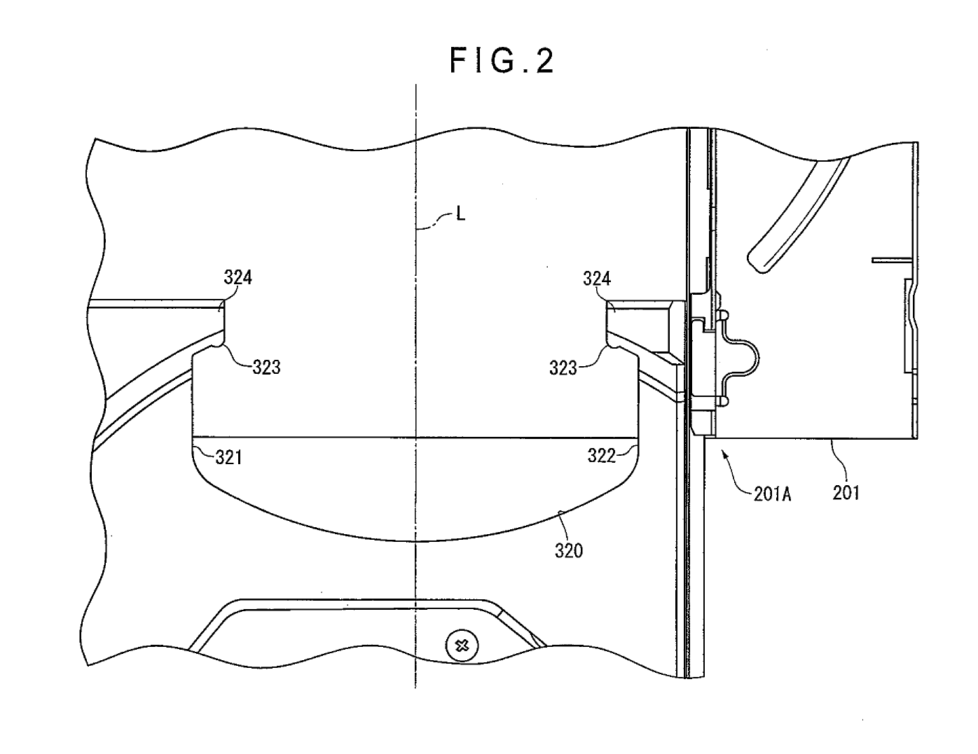

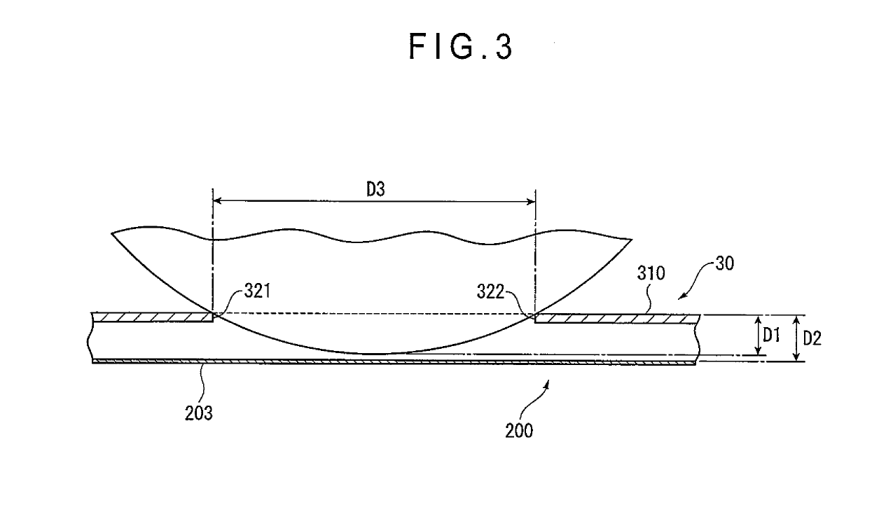

FIG. 1 is a plan view showing an arrangement of a tray and a case when the tray is ejected out of the case in the disc device according to the first exemplary embodiment of the invention. FIG. 2 is a plan view showing a vicinity of a rear face of the tray. FIG. 3 is a cross section showing the vicinity of the rear face of the tray.

In FIGS. 1 and 2, a numeral 100 represents the disc device functioning as a disc transfer device as well, and is a so-called slim disc device (or slim disc drive) installed in an electrical equipment such as a portable personal computer.

The disc device 100 conducts at least one of reading processing as information processing that reads out information recorded on a recording surface (not shown), and recording processing as information processing that records various pieces of information on the recording surface, the recording surface being provided on at least one side of a disc-shaped recording medium detachably attached to the disc device 100, e.g., an optical disc such as CD (Compact Disc) and DVD (Digital Versatile Disc).

The disc device 100 includes a case 200 and a tray 300.

The case 200 is shaped substantially like a box having an inner space with a metal plate.

The case 200 includes a case body 200A and a wing 200B provided on the right of the case body 200A in the above Figs. Top faces of the case body 200A and the wing 200B are flush with each other while bottom faces thereof are located at different height. Specifically, a distance from the top face to the bottom face of the wing 200B is smaller than a distance from the top face to the bottom face 203 of the case 200, the bottom face 203 also being of the case body 200A.

An opening 201A is formed at a front face 201 of the case 200. The tray 300 is disposed in the case body 200A in a manner advanceable and retractable through the opening 201A.

A rail portion 210 that is disposed along a moving direction of the tray 300, an opening/closing mechanism (not shown) for restricting the movement of the tray 300, and a circuit (not shown) for controlling operation of the disc device are provided inside the case 200.

The case 200 also includes a connector (not shown) to be connected to the circuit. The connector is connectable to an electrical equipment such as a personal computer arranged outside the disc device 100, to which a plug for transmitting/receiving various pieces of information from the electrical equipment or supplying electric power is connected.

The rail portion 210 is disposed on both sides of the case body 200A along the moving direction of the tray 300 from the opening 201A of the case 200. The rail portion 210 includes a pair of rail guides 212A and 212B fixed to the case 200, and a pair of rails 211 slidably provided to the tray 300.

The rail guides 212A and 212B extend from the both sides of the opening 201A of the case body 200A toward the depth side of the case 200 (the upper side in FIGS. 1 and 2). The rail guides 212A and 212B, which are made of, for example, polyoxymethylene (POM), are provided on a surface facing each other with, for example, a groove (not shown) substantially of a square C shape in cross section. The rails 211 each are longitudinally and slidably supported in the groove along the moving direction of the tray 300.

Each of the rails 211 is formed substantially of a square C shape in cross section with a metal plate so that insides of the rails 211 are slidably engageable with the both sides of the tray 300.

Further, the case 200 is provided with a restricting mechanism (not shown) that restricts the displacement of the rails 211 in the moving direction to prevent the rails 211 from dropping off from the rail guides 212A and 212B.

As shown in FIG. 1, the tray 300 is a substantially plate-shaped member made of synthetic resins and the like and is disposed in a manner advanceable and retractable from the opening 201A of the case 200. A decorative plate 301 for closing the opening 201A of the case 200 while the tray 300 is housed in the case 200 is provided at a first end of the tray 300.

An arc recess 310 serving as a holding recess is provided on an upper side of the tray 300, the arc recess having a diameter slightly larger than that of the optical disc as the recording medium. An upper face of the arc recess 310 is shaped substantially in a plane and serves as a holding surface for holding the optical disc.

On the tray 300, a disc processor 20 called a traverse mechanism is provided from the first end of the tray 300 near the decorative plate 301 substantially toward the center of the arc recess 310. An ejector button (not shown) is provided on a part of the decorative plate 301 of the tray 300. A control circuit (not shown) that controls the operation of the disc processor 20 and controls the movement of the tray 300 when the ejector button being electrically connected is provided on a bottom side of the tray 300. The control circuit is connected to the circuit of the case 200 via a flexible code and the like.

The disc processor 20 includes a base 21 that is shaped substantially like a plate with a metal plate and is supported by the tray 300. The elongated base 21 is formed from the first end of the tray 300 near the decorative plate 301 toward the center position thereof. The base 21 is longitudinally cut out to form an elongated processor opening 21A substantially at the center of the base 21.

A disc rotation driver 22 is disposed near a first end of the processor opening 21A of the base 21. The disc rotation driver 22 includes a spindle motor (not shown) and a turntable 23 integrated with an output shaft of the spindle motor, the turntable 23 being substantially like a disc and serving as a holder. The spindle motor is controllably connected to the control circuit and is driven by electric power supplied from the control circuit. The turntable 23, which is provided substantially at the center of the tray 300, detachably supports and rotatably holds the optical disc.

The base 21 includes an information processor 24. The information processor 24, which is supported by a pair of guide shafts 25 while bridging the guide shafts 25, is moved toward and away from the turntable 23 within the processor opening 21A by a moving mechanism (not shown). The information processor 24 is provided with a pickup that includes. a light source (not shown); a pick-up lens 24A for converging light of the light source; and a light sensor (not shown) for detecting specular light reflected from the optical disc.

The tray 300 is also provided with an opening/closing mechanism (not shown). The opening/closing mechanism includes a tray lock, and an opening/closing restricting portion.

The tray lock projects from the bottom side of the tray 300 toward the bottom face 203 of the case 200. The opening/closing restricting portion includes a restricting claw and an operating portion. The restricting claw is provided at a position on the bottom face 203 corresponding to the tray lock to be engaged with while the tray 300 is housed in the case 200. The operating portion includes, for example, a solenoid that is connected to and controlled in operation by the circuit. An output signal from the control circuit that recognizes an execution of an input operation of the ejector button is received at the circuit and the circuit controllably operates the solenoid. By the solenoid, the operating portion releases engagement between the restricting claw and the tray lock, i.e., separates the tray lock from the restricting claw, thereby allowing the tray 300 to advance. The tray lock and the restricting claw of the opening/closing restricting portion override each other to be engaged when the tray 300 is housed in the case 200.

An ejection restricting portion (not shown) is provided between lateral sides of the tray 300 and the rails 211. The ejection restricting portion restricts the advancing movement of the tray 300 when the tray 300 is ejected out of the case 200 at a predetermined distance. When the advancing movement of the tray 300 is restricted by the ejection restricting portion, a part of the tray 300 near the case 200 is housed in an inner space of the case 200 through the opening 201A. At this time, a part of the are recess 310 near the case 200 is also housed in the case 200.

As shown in FIGS. 1 and 2, a cutout portion 320 serving as a guide is disposed near the rear face opposite to an edge face on which the decorative plate 301 of the tray 300 is disposed, the cutout portion 320 being provided by a part of the arc recess 310 being cut.

The cutout portion 320 is cut out substantially in a square C shape from an edge near the rear face of the tray 300 toward the turntable 23. The cutout portion 320 includes straight cutout portions 321 and 322 as a pair of straight portions substantially in parallel to the moving direction of the tray 300.

As shown in FIG. 3, when a periphery of the optical disc is inserted into the cutout portion 320 in a manner substantially orthogonal to the upper face of the arc recess 310 of the tray 300 and the moving direction of the tray 300, D1 representing a distance between a peripheral end of the optical disc projecting from the bottom side of the tray 300 and the bottom side of the tray 300 and D2 representing a distance between the bottom side of the tray 300 and the bottom face 203 of the case 200, a distance D3 between the pair of the straight cutout portions 321 and 322 is arranged such that the distance D1 is smaller than the distance D2.

The pair of the straight cutout portions 321 and 322 each are positioned to have substantially the same distance from an imaginary line L (see FIGS. 1 and 2) passing through the center of the turntable 23 substantially in parallel to the moving direction of the tray 300.

Projecting portions 323 serving as a positioning portion are provided at rear-face-side ends of the pair of the straight cutout portions 321 and 322. Specifically, the projecting portions 323 each are shaped so as to project toward the turntable 23 in projecting pieces 324 that project toward the imaginary line L from the straight cutout portions 321 and 322. In the arrangement, the projecting portions 323 each are provided at positions where distances from the center of the turntable 23 to respective projecting distal ends substantially equal to a radius of the optical disc. Moreover, the projecting portions 323 each are provided at positions where distances from the upper face of the are recess 310 are smaller than a distance from the upper face of the arc recess 310 to a mounting surface on the turntable 23 for mounting the optical disc.

[Operation of Disc Device]

Next, operation(s) of the above disc device 100 will be described.

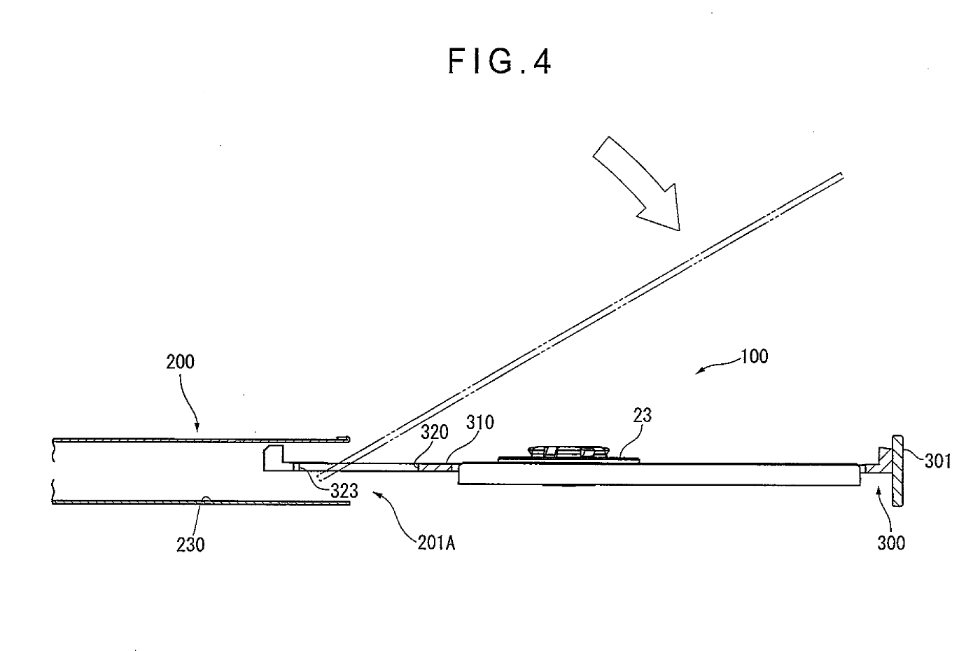

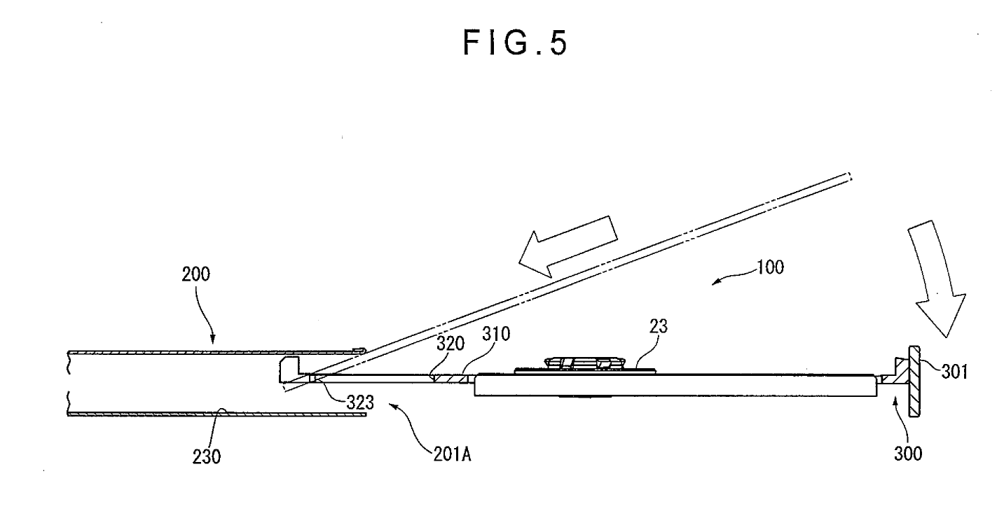

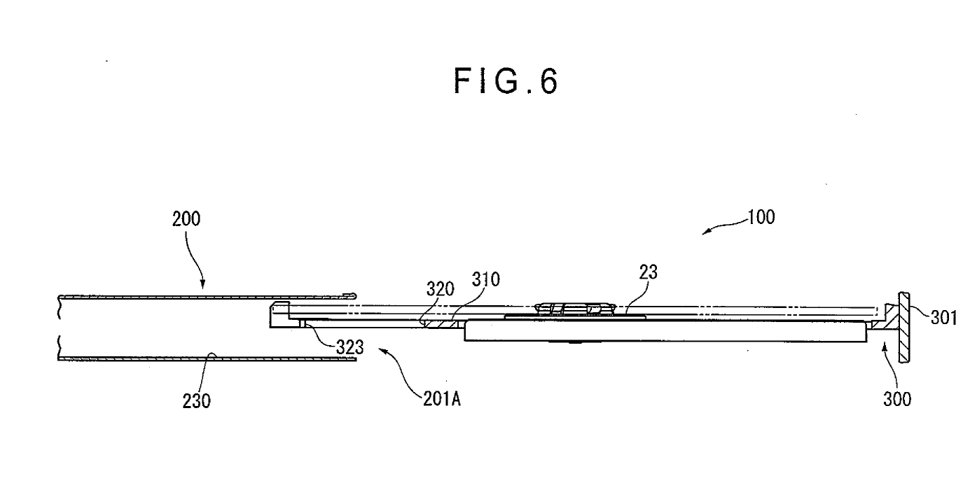

FIG. 4 is a lateral cross section in the disc device according to the first exemplary embodiment when an optical disc is inserted into the tray. FIG. 5 is a lateral cross section in the disc device according to the first exemplary embodiment when the optical disc is further inserted into the tray. FIG. 6 is a lateral cross section in the disc device according to the first exemplary embodiment when the optical disc is mounted on the tray.

When a user conducts an input operation on an ejector button provided on the decorative plate 301 while the tray 300 is housed in the case 200, the control circuit controls the operating portion of the opening/closing restricting portion to move the restricting claw and release engagement of the tray 300 with the tray lock, whereby the tray 300 becomes unlocked.

When the decorative plate 301 is, for example, drawn out while the tray 300 is unlocked, the tray 300 is supported by the rail portion 210 to be slid out of the opening 201A. When the tray 300 is drawn out to a predetermined position by such a slide movement that the user draws out the tray 300, as shown in FIG. 1, the tray 300 advances from the case 200 by the restricting mechanism of the case 200 and the ejection restricting portion of the tray 300 with a part of the tray 300 near the rear face being housed in the case 200.

As shown in FIG. 4, when the optical disc is put into the tray 300, a part of the periphery of the optical disc is engaged with the cutout portion 320 and the inserted end of the optical disc is inserted toward the bottom side of the tray 300 through the cutout portion 320. This arrangement allows an inserting angle of the optical disc to be larger than that of when the optical disc is inserted along the upper face of the arc recess 310.

As shown in FIG. 5, when the optical disc is further moved toward the rear face of the tray 300, the periphery of the optical disc is abutted with the projecting portions 323 to position the optical disc. At this time, since the distance from the projecting distal ends of the projecting portions 323 to the center of the turntable 23 substantially equals to the radius of the optical disc, the center of the optical device coincides with the center of the turntable 23 when the optical disc is rotated toward the tray 300 around the abutting position with the projecting portions 323. In other words, the projecting portions 323 allow the center of the optical disc to be positioned.

Subsequently, as shown in FIG. 6, after the optical disc is mounted on the turntable 23 and the tray 300 is pushed toward the rear face 202 of the case 200, the tray lock of the tray 300 overrides the restricting claw of the opening/closing restricting portion to be engaged with each other, whereby the tray 300 is locked with the case 200.

Subsequently, according to the input operation by the user, the control circuit conducts information processing of the inserted optical disc.

[Effect and Advantage of Disc Unit]

As described above, in the optical disc 100 according to the first exemplary embodiment, when the optical disc is mounted on the tray 300, the inserted distal end of the optical device is guided through the cutout portion 320 toward the bottom side of the tray 300 lower than the arc recess 310.

Accordingly, an inserting angle of the optical disc can be more increased than that of when the optical disc is inserted along the upper face of the arc recess 310. Consequently, this arrangement facilitates an inserting operation of the optical disc as well as a centering operation of the optical disc on the turntable 23. Further, since the inserting angle of the optical disc can be increased, the recording surface of the optical disc is prevented from contacting with a part of the tray 300 and turntable 23 and the optical disc can be favorably transferred into the case 200.

Moreover, since the part of the tray 300 near the rear face is housed in the case 200 during ejection of the tray 300, even when impact is given on the tray 300, the impact can be dispersed between the part of the tray 300 near the rear face inserted in the case 200 and the case 200. Consequently, the strength of the disc device 100 can be increased without the rail portion 210 inclining downward due to the impact or the weight of the tray 300.

The cutout portion 320 substantially in a square C shape is formed near the rear face of the tray 300 and the inserted distal end of the optical device is guided through the cutout portion 320 toward the bottom side of the tray 300 lower than the arc recess 310.

Thus, with such a simple arrangement that the cutout portion 320 is only provided in the tray 300, the optical disc can be favorably guided as described above.

Projecting portions 323 are provided at a periphery of the cutout portion 320 in a manner to project toward the turntable 23.

Accordingly, when the optical disc is inserted in the tray 300 near the rear face along the cutout portion 320, the optical disc can be positioned by the periphery thereof being abutted with the projecting portions 323. Accordingly, the optical disc can be favorably guided to the arc recess 310 of the tray 300 without the optical disc being excessively inserted to drop off from the tray 300.

The projecting portions 323 each are provided at positions where distances from projecting distal ends thereof to the center of the turntable 23 substantially equal to the radius of the optical disc.

Consequently, while the periphery of the optical disc is positioned in abutment with the projecting portions 323, the optical disc is rotated toward the tray 300 around the abutting positions with the projecting portions 323 to approach the tray 300, so that the center of the optical disc moves on the turntable 23. Thus, center alignment of the optical disc can be easily carried out.

A pair of straight cutout portions 321 and 322 of the cutout portion 320 each are substantially equidistantly formed from an imaginary line L passing through the turntable 23 substantially to extend in parallel to the moving direction of the tray 300.

Consequently, while the periphery of the optical disc is abutted with the straight cutout portions 321 and 322, the center of the optical disc can be positioned on the imaginary line L, so that center alignment of the optical disc can be easily carried out.

While the periphery of the optical disc is inserted into the cutout portion 320 in a manner substantially orthogonal to the upper face of the arc recess 310 of the tray 300 and the moving direction of the tray 300, a distance D3 between the pair of the straight cutout portions 321 and 322 is arranged such that the distance D1 between the peripheral end of the optical disc projecting from the bottom side of the tray 300 and the bottom side of the tray 300 is smaller than the distance D2 between the bottom side of the tray 300 and the to bottom face 203 of the case 200.

Consequently, the optical disc can be favorably transferred without the optical disc that projects from the cutout portion 320 toward the bottom side of the tray 300 being in contact with the bottom face 203 of the case 200.

### Second Exemplary Embodiment

### Arrangement of Disc Device

A disc device 100A according to a second exemplary embodiment of the invention will be described below with reference to the attached drawings.

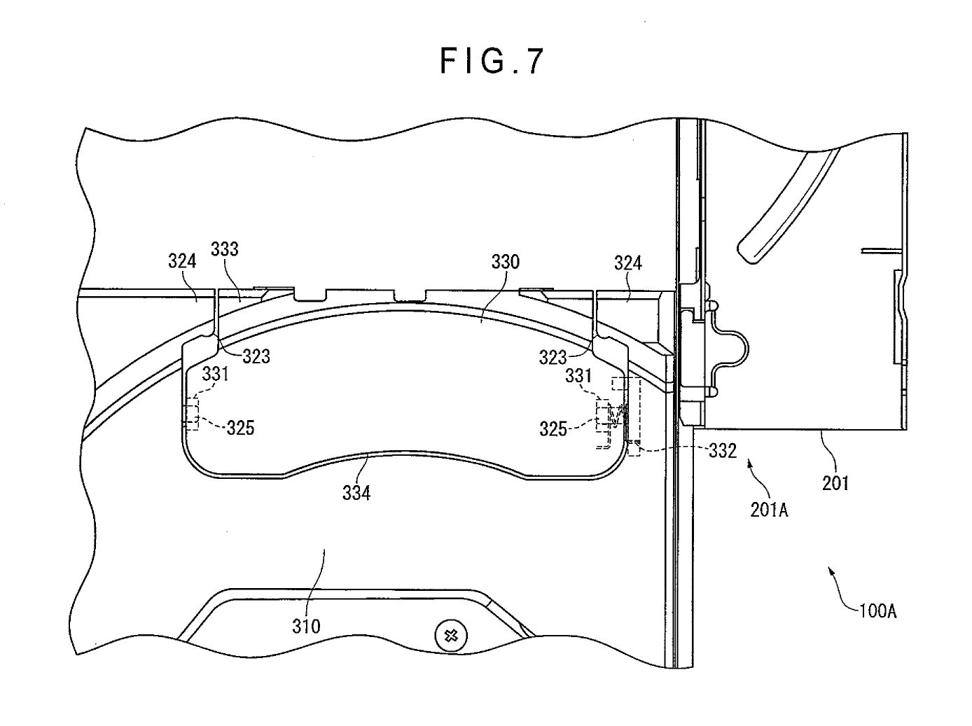

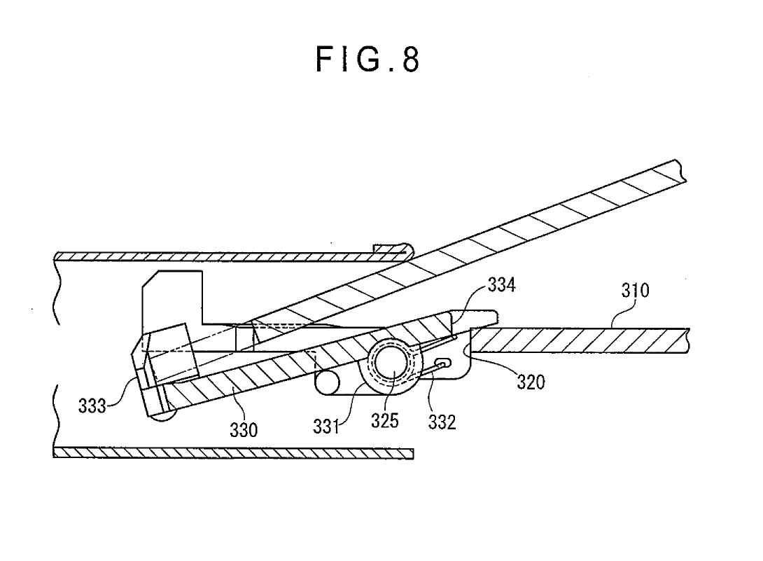

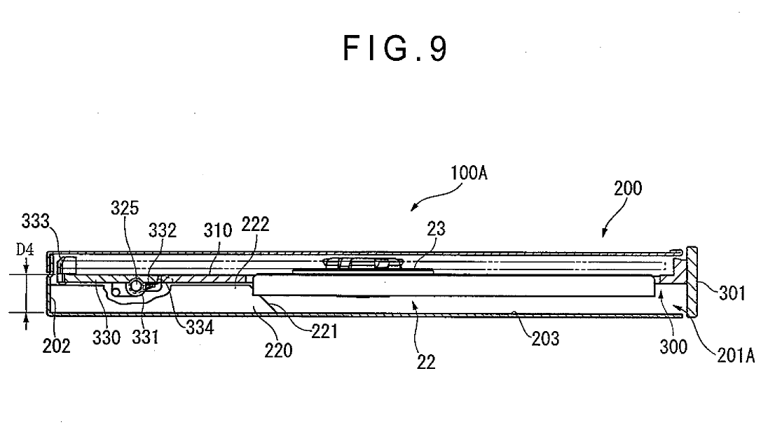

FIG. 7 is a plan view showing a vicinity of a rear face of a tray in the disc device according to the second exemplary embodiment. FIG. 8 is a lateral cross section showing the vicinity of the rear face of the tray in the disc device according to the second exemplary embodiment. FIG. 9 is a lateral cross section in the disc device according to the second exemplary embodiment when the tray is housed in the case. It should be noted that the same numerals are applied to the same arrangement as that of the first exemplary embodiment to omit or simplify descriptions of the numerals.

Similarly to the first exemplary embodiment, the disc device 100A according to the second exemplary embodiment includes a case 200 and a tray 300.

Similarly to the first exemplary embodiment, the case 200 is formed substantially like a box provided with an opening 201A on a front face 201.

As shown in FIG. 9, a guide-plate pushup cam 220 serving as a cam is provided in an inner space of the case 200. The guide-plate pushup cam 220 is provided on the bottom face 203 near the rear face 202 of the case 200, substantially at the center in a right/left direction and longitudinally in moving direction of the tray 300. As shown in FIG. 9, the guide-plate pushup cam 220 includes. an oblique portion 221 that is inclined from the front face 201 side to the rear face 202 side and from the bottom face 203 toward the top face; and a horizontal portion 222 that is formed continuously with the oblique portion 221 near the rear face 202 and extends toward the rear face 202. A distance D4 from the bottom face 203 to an end of the oblique portion 221 near the rear face 202 and an upper face of the horizontal portion 222 is substantially the same distance as the distance D2 from the bottom side of the tray 300 to the bottom face 203.

Similarly to the first exemplary embodiment, a rail portion 210 is disposed in the case 200. The tray 300 is held by the rail portion 210 in a manner advanceable and retractable through the opening 201A.

Similarly to the first exemplary embodiment, the tray 300 is provided with a decorative plate 301 for closing the opening 201A of the case 200 while tray 300 is housed in the case 200. The tray 300 can mount a large-diameter disc as a large-diameter (e.g. 12 cm) recording medium and a small-diameter disc as a small-diameter (e.g. 8 cm) recording medium.

An arc recess 310 that is slightly larger in diameter than the large-diameter disc is provided on a first plane of the tray 300.

Moreover, similarly to the first exemplary embodiment, the tray 300 is provided with a disc processor 20 from a first end near the decorative plate 301 substantially toward the center of the arc recess 310. Similarly to the first exemplary embodiment, the tray 300 further includes an ejection restricting portion (not shown).

Similarly to the first exemplary embodiment, a cutout portion 320 that is provided by cutting a part of the arc recess 310 is disposed in the tray 300 near the rear face.

As shown in FIGS. 7 and 8, a guide plate 330 serving as a turn plate is provided in the cutout portion 320 of the tray 300. The guide plate 330, made of synthetic resins and the like, is formed such that a thickness of the guide plate 330 is smaller than a height from the upper face of the arc recess 310 to the mounting surface of the turntable 23.

The guide plate 330 has a shaft support 331 near the front face (near the decorative plate 301). A rotary shaft 325 projecting from the straight cutout portions 321 and 322 near the front face of the cutout portion 320 toward the guide plate 330 is inserted through the shaft support 331. With this arrangement, the guide plate 330 is rotatably held by the tray 300. The height of the shaft support 331 is arranged such that the upper face of the guide plate 330 is substantially flush with the upper face of the arc recess 310 while the guide plate 330 is rotated toward the upper side of the tray 300. A rotatable range of the guide plate 330 is restricted such that a rear-face end of the guide plate 330 does not interfere with the bottom face 203 of the case 200 while the guide plate 330 is rotated toward the bottom side of the tray 300 in a direction separating from the tray 300.

The guide plate 330 is provided with a biasing spring 332 as a biasing unit between the shaft support 331 and the rotary shaft 325. The biasing spring 332 biases the guide plate 330 such that the side of the guide plate 330 near the rear face is rotated toward the bottom side of the tray 300. Accordingly, when the tray 300 is ejected out of the case, the side of the guide plate 330 near the rear face is rotated toward the bottom side of the tray 300. When the tray is housed in the case 200 and the rear-face end of the guide plate 330 is abutted with the oblique portion 221 of the guide-plate push-up cam 220 in the case 200, the guide plate 330 is pushed up toward the upper side of the tray 300. When the rear-face end of the guide plate 330 is abutted with the horizontal portion 222 of the guide-plate pushup cam 220, the guide plate 330 is pushed up to a position where the upper face of the guide plate 330 is substantially flush with the upper face of the arc recess 310.

A rising portion 333 serving as a large-diameter recording medium abutting portion that projects toward the upper face of the tray is provided on the guide plate 330 near the rear face. The rising portion 333 is shaped of an arc such that a distance from the center of the turntable 23 is substantially the same as or slightly larger than a radius of the large-diameter disc when the guide plate 330 is rotated in a manner such that the upper face of the guide plate 330 is substantially flush with the upper side of the tray 300.

An arc cutout portion 334 serving as a small-diameter recording medium abutting portion is cut out in an arc around the turntable 23 at a front-face end of the guide plate 330, the end being closer to the front face than the shaft support 331.

A distance from the center of the turntable 23 to the arc cutout portion 334 is equal to the radius of the small-diameter disc (e.g. 8 cm). When the tray 300 is ejected out of the case 200 and the guide plate 330 is rotated toward the bottom side of the tray 300, an end surface of the arc cutout portion 334 projects toward the upper side of the tray 300. At this time, the end surface of the arc cutout portion 334 projects toward the upper side of the tray 300 by a thickness of the guide plate 330. A projecting distance of the arc cutout portion 334 is not particularly limited as long as the projecting distal end is positioned closer to the tray 300 than the mounting surface of the turntable 23.

[Operation of Disc Device]

Next, an operation of the disc device 100A according to the second exemplary embodiment will be described below with reference to the attached drawings.

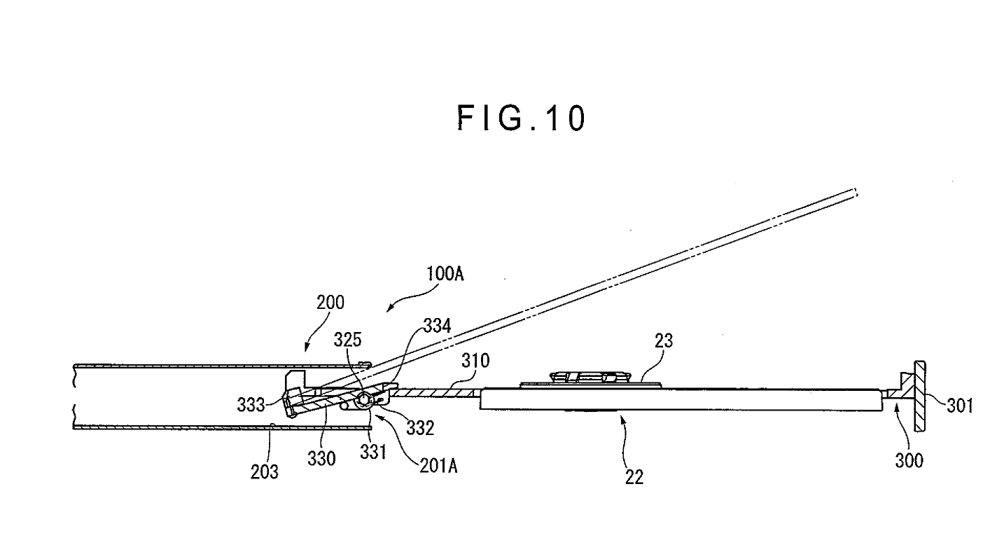

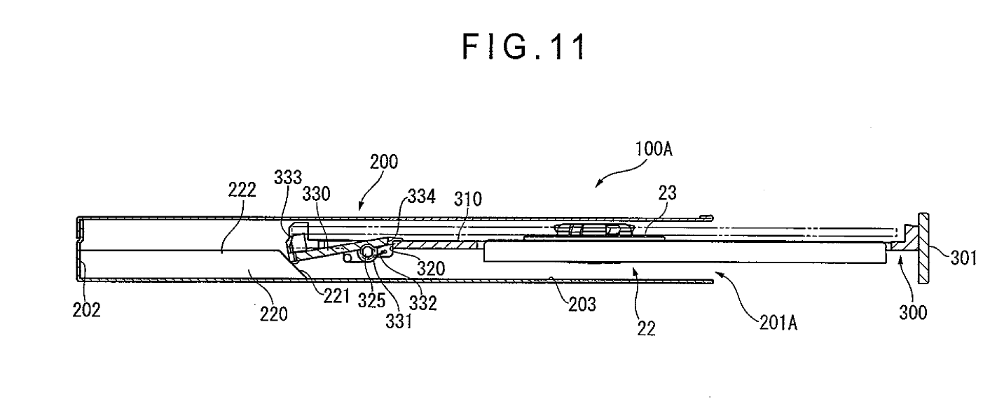

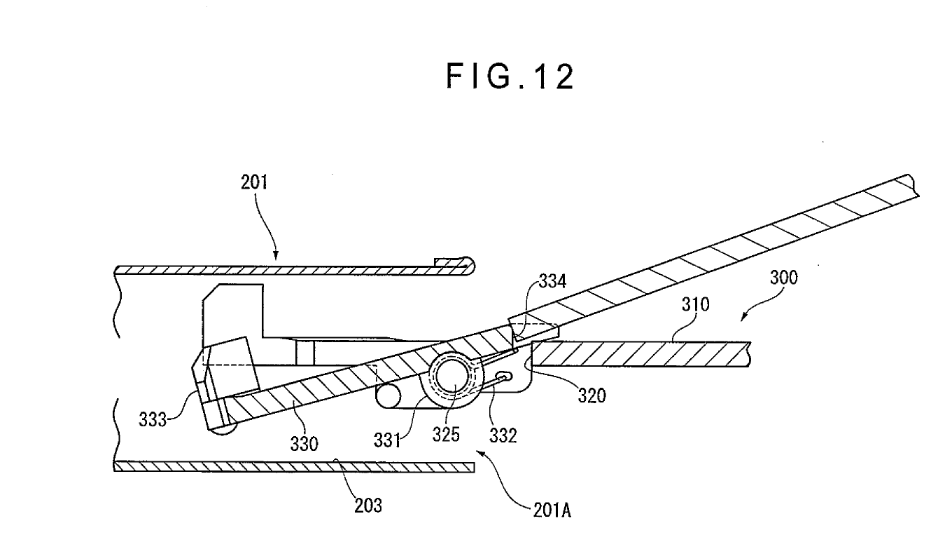

FIG. 10 is a lateral cross section in the disc device according to the second exemplary embodiment when a large-diameter disc is inserted into the tray. FIG. 11 is a lateral cross section in the disc device according to the second exemplary embodiment when the tray is being housed in the case. FIG. 12 is a lateral cross section in the disc device according to the second exemplary embodiment when a small-diameter disc is inserted into the tray.

Similarly to the first exemplary embodiment, when a user conducts an input operation on an ejector button provided on the decorative plate 301 while the tray 300 is housed in the case 200, the control circuit controls the operating portion of the opening/closing restricting portion to move the restricting claw and release engagement of the tray 300 with the tray lock, whereby the tray 300 becomes unlocked.

While the tray 300 is unlocked, for example, the decorative plate 301 is drawn out, so that the tray 300 is supported by the rail portion 210 to be slid out of the opening 201A. When the tray 300 is drawn out to a predetermined position by such a slide movement that the user draws out the tray 300, as shown in FIG. 1, the tray 300 advances from the case 200 by the restricting mechanism of the case 200 and the ejection restricting portion of the tray 300 with a part of the tray 300 near the rear face being housed in the case 200.

Under this condition, when the large-diameter disc is inserted to the tray 300 at a predetermined inserting angle, as shown in FIG. 10, a part of the periphery of the large-diameter disc is inserted substantially along the upper face of the guide plate 330. The guide plate 330 is rotated toward the bottom side of the tray 300 by a biasing force of the biasing spring 332. Accordingly, when the large-diameter disc is inserted substantially along the upper face of the guide plate 330, the inserted distal end is inserted toward the bottom side of the tray 300 lower than the arc recess 310, thereby allowing the inserting angle of the optical disc to be larger than the inserting angle of an arrangement where the optical disc is inserted along the upper face of the arc recess 310.

When the optical disc is further moved toward the rear face of the tray 300, the optical disc is abutted with the rising portion 333 and the projecting portion 323 to be positioned. In the arrangement, since the distance from the projecting distal end of the projecting portion 323 and the rising portion 333 to the center of the turntable 23 substantially equals to the radius of the optical disc, the center of the optical device coincides with the center of the turntable 23 when the optical disc is rotated toward the tray 300 around the abutting position with the projecting portion 323. In other words, the projecting portion 323 and the rising portion 333 allow the center alignment of the large-diameter disc.

When the small-diameter disc is inserted into the tray 300 at a predetermined angle while the tray 300 is ejected out of the case, an inserted end of the small-diameter disc is abutted with the arc cutout portion 334 of the guide plate 330 projecting from the upper face of the arc recess 310. The arc cutout portion 334 is formed in an arc whose distance from the turntable 23 substantially equals to the radius of the small-diameter disc. Accordingly, the center of the small-diameter device substantially coincides with the turntable 23 when the small-diameter disc is rotated toward the tray 300 around the abutting position with the arc cutout portion 334 while the small-diameter disc is abutted with the arc cutout portion 334. In other words, the arc cutout portion 334 allows the center alignment of the small-diameter disc.

Subsequently, when the optical disc is mounted on the turntable 23 and the tray 300 is pushed toward the rear face 202 of the case 200, as shown in FIG. 11, the guide plate 330 is abutted with the oblique portion 221 of the guide-plate pushup cam 220 to be pushed up toward the upper side of the tray 300. When the tray 300 is completely housed in the case 200, the upper face of the guide plate 330 and the upper face of the arc recess are substantially flush with each other. The tray lock overrides the restricting claw of the opening/closing restricting portion to be engaged with each other, so that the tray 300 is locked in the case 200.

Subsequently, according to the input operation by the user, the control circuit conducts information processing of the inserted optical disc.

[Effect and Advantage of Disc Unit]

As described above, the disc device 100A according to the second exemplary embodiment provides the following effect and advantage as well as those of the disc device 100 according to the first exemplary embodiment.

In the disc device 100A, the cutout portion 320 is provided with the guide plate 330 that is rotatable in a direction for the side of the guide plate 330 near the rear face is separated away from the upper side of the tray 300.

Accordingly, by inserting the large-diameter disc along the upper face of the guide plate 330, the inserted distal end of the optical disc is easily guided toward the bottom side of the tray 300 lower than the arc recess 310. Consequently, the inserting angle of the optical disc to the tray 300 can be more increased than the inserting angle of an arrangement where the optical disc is inserted along the upper face of the arc recess 310 of the tray 300. In addition, the input operation of the optical disc is more easily carried out than the disc device 100 according to the first exemplary embodiment and the center alignment operation of the optical disc with the turntable 23 is also easily carried out.

The guide plate 330 is rotated in a direction to be separated away from the upper side of the tray 300 when the tray 300 is ejected out of the case 200. Alternatively, the guide plate 330 is rotated toward the upper side of the tray 300 by the guide-plate pushup cam 220 when the tray 300 is housed in the case 200.

Accordingly, when the tray 300 is housed in the case 200 and is on play to carry out a predetermined information processing operation by the information processor 24, the front-face end of the guide plate 330 does not project toward the upper side of the tray 300, thereby preventing the guide plate 330 from contacting with the optical disc.

The rising portion 333 is provided at the rear-face end of the guide plate 330.

Accordingly, the rising portion 333 positions the periphery of the large-diameter disc and prevents the large-diameter disc from dropping off. Since the rising portion 333 is provided at a position where the distance from the turntable 23 substantially equals to the radius of the large-diameter disc, when the large-diameter disc in abutment with the rising portion 333 is simply rotated toward the tray 300, the center of the large-diameter disc can be favorably guided to the turntable 23 to be easily positioned.

The arc cutout portion 334, the distance of which from the turntable 23 substantially equals to the radius of the small-diameter disc, is provided at the front-face end of the guide plate 330.

Accordingly, when the guide plate 330 is rotated in a direction to be separated away from the tray 300, the end surface of the arc cutout portion 334 can project over the upper face of the arc recess 310. When the small-diameter disc is mounted on the tray 300, the periphery of the small-diameter disc can be abutted with the arc cutout portion 334 to be positioned.

The guide plate 330 is biased by the biasing spring 332 in a direction to be apart from the tray.

Accordingly, when the tray 300 is housed in the case 200, the guide plate 330 is biased to the horizontal portion 222 of the guide-plate pushup cam 220 by the biasing force of the biasing spring 332, thereby preventing vibration caused by, for example, rotation of the turntable 23. Consequently, noise caused by vibration of the guide plate 330 can be prevented, thereby facilitating favorable information processing operation.

### Other Embodiments

It should be noted that the present invention is not limited to the exemplary embodiments described above, but may include modifications described below within a scope where an object of the present invention can be achieved.

In the above exemplary embodiments, the disc device 100 and 100A are exemplified by a thin disc device capable of being mounted on a notebook personal computer and the like, but an arrangement is not limited to this. The present invention may be implemented on a disc device mounted on, for instance, a desktop personal computer and the like.

Alternatively, the present invention is not limited to such an arrangement that a disc device is installed in a notebook personal computer, but the disc device may be installed in, for instance, a gaming machine, a video device for recording/reproducing image data, and the like.

Further, the disc device may perform only one of the reading processing and recording processing.

The recording medium is not limited to the optical disc, but may be any kind of disc recording media such as a magneto optical disc or a magnetic disc.

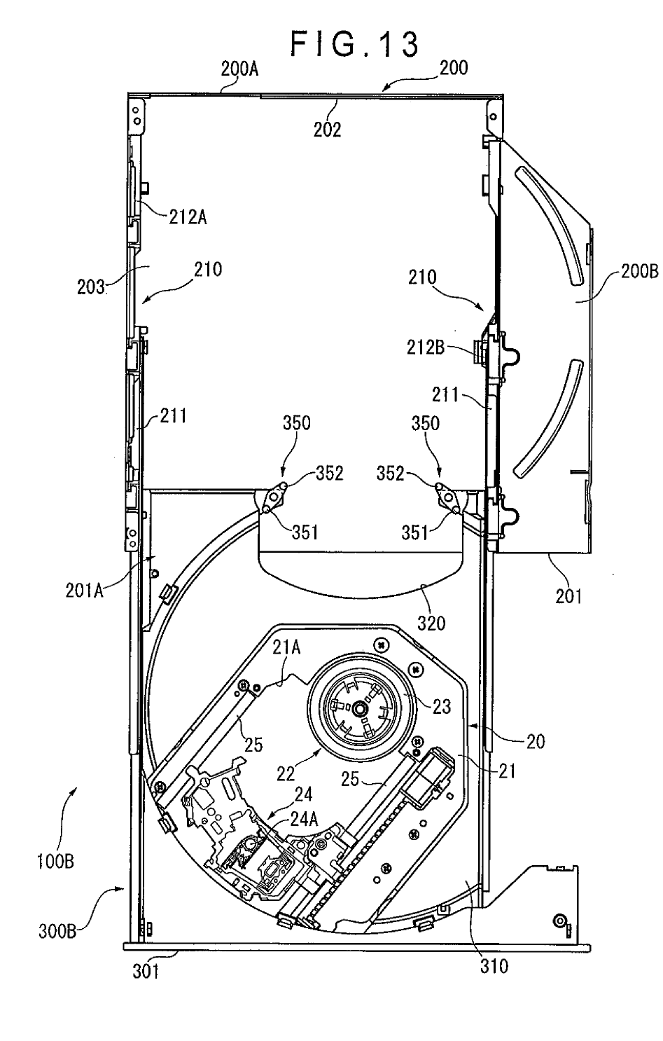

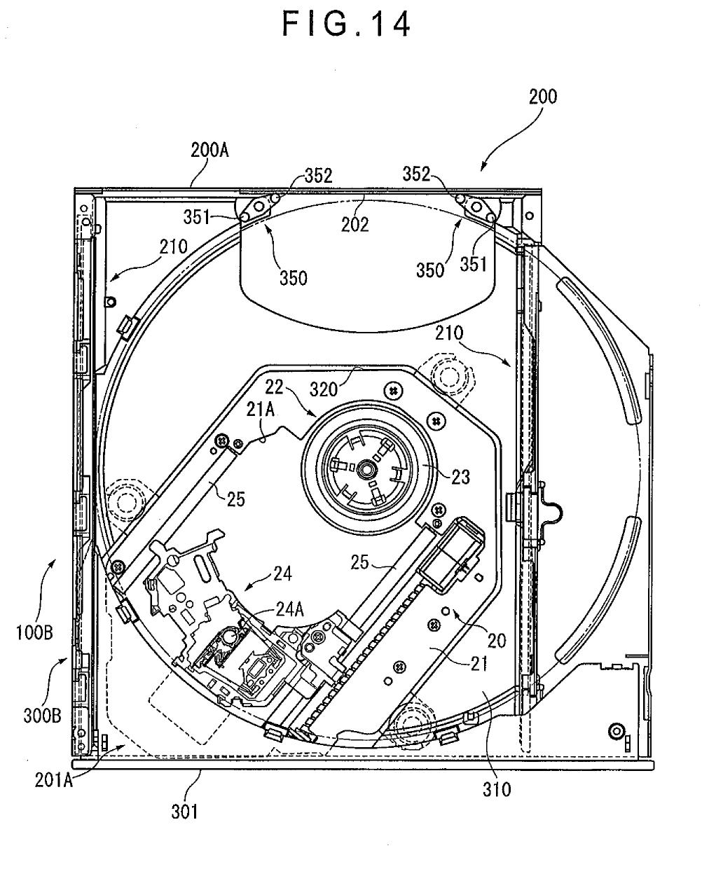

A positioning portion is exemplified by the projection portions 323, but an arrangement is not limited to this. For example, as shown in FIGS. 13 and 14, the positioning portion may be movable.

In FIGS. 13 and 14, the disc device 100B includes a case 200 and a tray 300B substantially similarly to the first exemplary embodiment. As shown in FIG. 13, in the tray 330B a positioning lever 350 is provided on a projecting piece 324 on the pair of the straight cutout portions 321 and 322 near the rear face in the cutout portion 320.

A longitudinal center of the elongated positioning lever 350 is rotatably supported by the projecting piece 324. The positioning lever 350 is provided in a manner to incline in a direction to be apart from the imaginary line L through the turntable 23 in parallel to the moving direction of the tray 300 in accordance with the longitudinal direction of the positioning lever 350 moving from the rear face to the front face.

A disc abutting portion 351 serving as the positioning portion that can be abutted with the periphery of the optical disc is provided at a distal end of the positioning lever 350 near the front face. The disc abutting portion 351 is a substantially cylindrical member, a central axis of which is substantially orthogonal to the tray 300, the periphery of the optical disc being abutted with an outer circumferential surface of the cylinder to position the optical disc.

A case abutting portion 352 serving as a rotation acting portion that is abutted with the rear face 202 of the case 200 is provided at a rear-face end of the positioning lever 350 when the tray 300 is housed in the case 200. When the case abutting portion 352 is abutted with the rear face 202 of the case 200, the positioning lever 350 is rotated in a direction for the disc abutting portion to go apart from the periphery of the optical disc.

The positioning lever 350 is biased in a direction for the disc abutting portion 351 to approach the turntable 23 by a biasing member such as a torsion spring and the like. Specifically, the biasing member biases the disc abutting portion 351 in a manner that the disc abutting portion 351 moves to a position where the distance from the turntable 23 substantially equals to the radius of the optical disc. With this arrangement, when the tray 300 is ejected out of the case 200, the disc abutting portion 351 moves to a position where the disc abutting portion 351 can position the periphery of the optical disc.

With this arrangement, when the tray 300 is ejected out of the case 200, the disc abutting portion 351 is abutted with the periphery of the optical disc and moves to a position where the disc abutting portion 351 can position the periphery of the optical disc. Accordingly, by inserting the optical disc at a predetermined angle in a manner such that the optical disc is abutted with the disc abutting portion 351 when the optical disc is mounted on the tray 300, the optical disc can be easily mounted on the tray 300. When the tray 300 is housed in the case 200, the case abutting portion 352 is abutted with the rear face 202 of the case 200 to rotate the positioning lever 350 and the disc abutting portion 351 moves in a direction separating from the periphery of the optical disc. Accordingly, since the disc abutting portion 351 moves apart from the periphery of the optical disc, the optical disc can be favorably rotated by the turntable 23.

In FIGS. 13 and 14, the positioning lever is exemplified by the positioning lever 350 that is rotatably provided substantially at the longitudinal center on the tray 300. However, any other arrangements such as an arrangement where a first longitudinal end is rotatably held and a disc abutting portion is provided on a second end; and an arrangement where a positioning lever moves in the right/left direction and a disc abutting portion moves in the right/left direction to be apart from a optical disc when the tray 300 is housed may be applied.

The above exemplary embodiment is arranged such that the cutout portion 320 is provided on the tray 300 near the rear face and the inserted distal end of the optical disc is guided toward the bottom side of the tray 300 to increase the inserting angle of the optical disc. However, a recess may be formed on the tray 300 so as to have a longer distance from the upper side of the tray 300 than that from the arc recess 310 and the inserted distal end of the optical disc may be guided to the recess.

The cutout portion is exemplified by the cutout portion 320 that is cut out substantially in a square C shape on the tray 300 near the rear face. However, any other arrangements may be applied. an opening like a window may be provided on the arc recess 310 near the rear face and the inserted distal end of the optical disc may be guided through the window.

The projecting portion 323 and the disc abutting portion 351 of the positioning lever 350 are exemplified as the positioning portion, but an arrangement is not limited to this. For example, rails may be disposed along the straight cutout portions 321 and 322 of the cutout portion 320 and a movable positioning portion may be provided along the rails. Further, the disc abutting portion may be provided at a distal end of an arm rotatably provided on the tray 300 and the periphery of the optical disc may be positioned by the disc abutting portion.

The projecting portion 323 that positions the large-diameter disc by the abutment with the periphery of the large-diameter disc is exemplified. However, a projecting portion that positions the small-diameter disc by the abutment with the periphery of the small-diameter disc may be separately arranged on the straight cutout portions 321 and 322.

Specific structures and the operating procedures for the present invention may be appropriately modified as long as an object of the present invention can be achieved.

### [Advantages of Modifications]

As described above, in the optical disc 100, when the optical disc is mounted on the tray 300, the inserted distal end of the optical device is guided through the cutout portion 320 toward the bottom side of the tray 300 lower than the arc recess 310.

Accordingly, the inserting angle of the optical disc can be more increased than the inserting angle of an arrangement where the optical disc is inserted along the upper face of the arc recess 310. Consequently, an inserting operation of the optical disc as well as a centering operation of the optical disc on the turntable 23 can be facilitated. Further, since the inserting angle of the optical disc can be increased, the recording surface of the optical disc is prevented from contacting with a part of the tray 300 and turntable 23 and the optical disc can be favorably transferred in the case 200.

### INDUSTRIAL APPLICABILITY

The present invention is applicable to a disc transfer device for transferring a disc recording medium, and a disc device.

1. A disc transfer device, comprising:
a case comprising an opening on at least one side thereof and an inner space connected to the opening; and
a substantially plate-shaped tray that is advanceable and retractable through the opening of the case and is provided with a holding recess having a holding surface capable of holding a disc-shaped recording medium at a first surface, wherein
the tray comprises a cutout portion that is cut out so as to connect the first surface and a second surface of the tray and provided on the holding recess near the case in a moving direction of the tray, the cutout portion guiding a periphery of the recording medium to be inserted from the holding surface to the second surface where the holding recess is not provided, and including a positioning portion on a periphery of the cutout portion for positioning the periphery of the recording medium that projects toward an inner side of the holding surface substantially along the periphery of the cutout portion.

2. (canceled)

3. (canceled)

4. (canceled)

5. The disc transfer device according to claim 1, wherein
the positioning portion is abutted with the periphery of the recording medium when the tray is ejected out of the case and separates from the periphery of the recording medium when the tray is housed in the case, the positioning portion being movably provided substantially along the periphery of the cutout portion.

6. The disc transfer device according to claim 5, further comprising:
an elongated positioning lever that is positioned substantially along the periphery of the cutout portion and is rotatably supported at a center thereof, wherein the positioning portion is provided at a longitudinal distal end of the positioning lever.

7. The disc transfer device according to claim 6, wherein
the case comprises a rear face opposing to the one side provided with the opening, and
the positioning lever comprises a rotation acting portion that is provided at a second longitudinal end and opposes the rear face of the case, the rotation acting portion being abutted with the rear face to rotate the positioning lever when the tray is housed in the case.

8. The disc transfer device according to claim 1, wherein
the tray comprises a holder for holding a center of the recording medium on the first surface, and
the positioning portion is provided at a position where a distance from a center of the holder substantially equals to a radius of the recording medium.

9. The disc transfer device according to claim 1, wherein
the cutout portion comprises a pair of straight portions that are substantially in parallel to an imaginary line extending from the holder along the moving direction of the tray and distances from the imaginary line to the straight portions are substantially equal to each other, and
the positioning portion is substantially positioned along the straight portions.

10. The disc transfer device according to claim 9, wherein
the case comprises a bottom face opposing to the tray when the tray is housed, and
a distance between the pair of the straight portions is defined such that when the recording medium is inserted in the cutout portion substantially orthogonally to the holding surface and the moving direction of the tray, a projection dimension of an inserted distal end of the recording medium that projects from the second surface of the tray is smaller than a gap distance between the tray and the bottom face.

11. A disc transfer device, comprising:
a case comprising an opening on at least one side thereof and an inner space connected to the opening; and
a substantially plate-shaped tray that is advanceable and retractable through the opening of the case and is provided with a holding recess having a holding surface capable of holding a disc-shaped recording medium at a first surface, wherein
the tray comprises. a cutout portion that is cut out so as to connect the first surface and a second surface of the tray and provided on the holding recess near the case in a moving direction of the tray, the cutout portion guiding a periphery of the recording medium to be inserted from the holding surface to the second surface where the holding recess is not provided; and
the cutout portion comprises a turn plate that is substantially in parallel to the holding surface and is rotatably provided around a rotary shaft substantially orthogonal to the moving direction of the tray, a side of the turn plate near the case in the moving direction moving toward and away from the holding surface.

12. The disc transfer device according to claim 11, wherein
the turn plate is rotated in a direction to be separated from the holding surface when the tray is ejected out of the case and is rotated to a position substantially flush with the holding surface when the tray is housed in the case.

13. The disc transfer device according to claim 11, wherein
the tray comprises the holder for holding the center of the recording medium on the first surface, and mounts a large-diameter recording medium and a small-diameter recording medium thereon in a transferable manner, and
the turn plate comprises a small-diameter recording medium positioning portion substantially in an arc that positions the small-diameter recording medium by being abutted with a periphery of the small-diameter recording medium at a position where the distance from the center of the holder substantially equals to a radius of the small-diameter recording medium.

14. The disc transfer device according to claim 11, wherein
the turn plate comprises a large-diameter recording medium positioning portion substantially in an arc that positions the large-diameter recording medium by being abutted with a periphery of the large-diameter recording medium at a position where the distance from the center of the holder substantially equals to a radius of the large-diameter recording medium.

15. The disc transfer device according to claim 13, wherein
the small-diameter recording medium positioning portion is provided in an advancement side in the moving direction of the tray relative to the rotary shaft.

16. The disc transfer device according to claim 11, wherein
the tray comprises a biasing unit for biasing the turn plate in a direction to be separated from the holding surface, and
the case comprises a cam for moving the turn plate in a direction to approach the holder when the tray is housed in the inner space.

17. A disc device, comprising the disc transfer device according to claim 1:
the holder for holding the recording medium, and
an information processor for performing at least one of a reading processing that reads out information on the recording medium held by the holder and a recording processing that records information on the recording medium.
